(19) United States
(12) Patent Application Publication
(10) Pub. No.: US 2011/0079334 A1
(43) Pub. Date: Apr. 7, 2011

(54) TIRE TREAD HAVING IMPROVED CONTACT PRESSURE DISTRIBUTION

(76) Inventors: Andreas Bott, Alzenau (DE); Boris Erceg, Hanau (DE); Markus Brachtl, Linsengericht (DE); Yasuo Wada, Frankfurt (DE)

(21) Appl. No.: 12/572,479

(22) Filed: Oct. 2, 2009

(51) Int. Cl. B60C 11/04

(52) U.S. Cl. 152/209.14

(57) ABSTRACT

A multi-rib tire tread has a plurality of circumferential spaced apart ribs in an axial direction, adjacent ribs separated by a circumferential grooves and each rib having sides extending radially outward to a radially outward contact surface. The outward contact surface of a central rib has an outwardly convex curvature in an axial direction more rounded than a tread curvature. A first lateral rib and a second lateral rib are positioned adjacent opposite sides of the central rib, each lateral rib having an outwardly convex curvature in an axial direction more rounded than a tread curvature. The convex curvature of the first and second lateral ribs are less rounded than the central rib. The radius of curvature of the center rib is within a range of 170 and 270 millimeters; the radius of curvature of the first lateral rib is within a range of 80 to 180 millimeters; and the radius of curvature of the second lateral rib is within a range of 100 to 200 millimeters.

### FIELD OF THE INVENTION

The invention relates generally to a tire tread for general purpose passenger vehicle usage and, in particular to a tire tread having improved contact distribution capability across a contact footprint.

### BACKGROUND OF THE INVENTION

Tire treads are designed to accomplish a number of objectives and meet numerous performance criteria and it is generally desirable to construct a tread providing good durability, traction, and handling performance on a range of surface conditions. Passenger tires are typically configured having multiple spaced apart and parallel circumferential ribs separated by circumferential grooves. The ribs are each formed by a circumferential array of block elements. The tire tread deflects during use to form a road surface contact footprint in which contact pressure is distributed across the rib pattern. Some tread patterns can develop a concentration of contact pressure in certain regions of the ribs within the tire footprint, particularly along the edges of block elements forming the rib. Such concentrations of pressure can reduce the efficiency of the tread and negatively affect tire performance and durability. Therefore, it is important to the durability, traction, and wear of the tread, that the tread be constructed in a manner that distributes contact pressure evenly across the tire footprint so as to avoid undesirable concentrations of contact pressure.

### SUMMARY OF THE INVENTION

In an aspect of the invention, a multi-rib tire tread has a plurality of circumferential spaced apart ribs in an axial direction, adjacent ribs separated by a circumferential grooves and each rib having sides extending radially outward to a radially outward contact surface. The outward contact surface of a central rib has an outwardly convex curvature in an axial direction more rounded than a tread curvature.

In another aspect, a first lateral rib and a second lateral rib are positioned adjacent opposite sides of the central rib, each lateral rib having an outwardly convex curvature in an axial direction more rounded than a tread curvature. The convex curvature of the first and second lateral ribs are less rounded than the central rib.

The radius of curvature, in a further aspect, of the center rib is within a range of 170 and 270 millimeters; the radius of curvature of the first lateral rib is within a range of 80 to 180 millimeters; and the radius of curvature of the second lateral rib is within a range of 100 to 200 millimeters.

### DEFINITIONS

“Aspect ratio” of the tire means the ratio of its section height (SH) to its section width (SW) multiplied by 100 percent for expression as a percentage.

“Asymmetric tread” means a tread that has a tread pattern not symmetrical about the center plane or equatorial plane EP of the tire.

“Axial” and “axially” means lines or directions that are parallel to the axis of rotation of the tire.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Groove” means an elongated void area in a tread that may extend circumferentially or laterally about the tread in a straight, curved, or zigzag manner. Circumferentially and laterally extending grooves sometimes have common portions. The “groove width” is equal to tread surface area occupied by a groove or groove portion, the width of which is in question, divided by the length of such groove or groove portion; thus, the groove width is its average width over its length. Grooves may be of varying depths in a tire. The depth of a groove may vary around the circumference of the tread, or the depth of one groove may be constant but vary from the depth of another groove in the tire. If such narrow or wide grooves are substantially reduced depth as compared to wide circumferential grooves which the interconnect, they are regarded as forming “tie bars” tending to maintain a rib-like character in tread region involved.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint as measured under normal load and tire inflation, the lines being parallel to the equatorial centerplane.

“Net contact area” means the total area of ground contacting tread elements between the lateral edges around the entire circumference of the tread divided by the gross area of the entire tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Tread element” or “traction element” means a rib or a block element defined by having a shape adjacent grooves.

“Tread Arc Width” means the arc length of the tread as measured between the lateral edges of the tread.

“Tread Radius” means the radius of the arc of the tread as measured between the lateral edges of the tread for a given tire size.

### BRIEF DESCRIPTION OF THE DRAWINGS

The invention will be described by way of example and with reference to the accompanying drawings in which:

FIG. 1 is a front elevation view of a representative tire having a tread pattern formed by spaced apart circumferential ribs.

FIG. 2 is a cross-sectional view of the tire of FIG. 1.

FIG. 3 is a cross-sectional view of the tire showing the tire tread contacting a road surface.

FIG. 4 is an enlarged sectional view the tire tread region identified in FIG. 2.

FIG. 5 is an enlarged sectional view of a tire tread ribs configured pursuant to the invention and showing a series of case study variations to the convex curvature of a center tread rib.

FIG. 6A is a pressure distribution diagram of a tire footprint in case study 1 subject to indicated parameters.

FIG. 6B is a pressure distribution diagram of a tire footprint in case study 1 subject to indicated modified parameters.

FIG. 6C is a pressure distribution diagram of a tire footprint in case study 1 subject to indicated modified parameters.

FIG. 6D is a pressure distribution diagram of a tire footprint in case study 1 subject to the indicated modified parameters.

FIG. 7A is a pressure distribution diagram of a tire footprint in case study 2 subject to the indicated parameters.

FIG. 7B is a pressure distribution diagram of a tire footprint in case study 2 subject to the indicated modified parameters

### DETAILED DESCRIPTION OF THE INVENTION

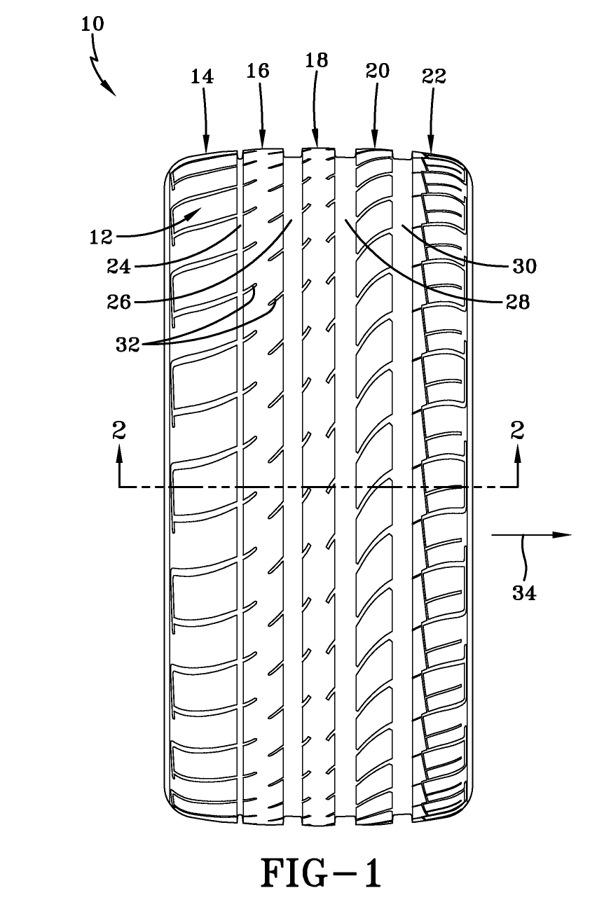

Referring to FIG. 1, a tire 10 is shown having a representative tread pattern 12 formed by circumferential ribs 14, 16, 18, 20, 22. The ribs are spaced apart by circumferential grooves 24, 26, 28, and 30. More or fewer ribs may constitute the pattern 12 is desired. The rib 18 lies on the equatorial centerplane of the tire 10. Each rib is uniquely constructed of respective tread elements; intermediary ribs 18, and 20 being of generally solid rib configuration with offset groove fingers 32 into the ribs from opposite rib edges. Ribs 14, 16, and 22 are shown as constructed from an array of discrete rib elements separated within the rib by lateral grooves. The tread pattern 12 extends between edges of the tire in a axial direction indicated in FIG. 1 by the numeral 34.

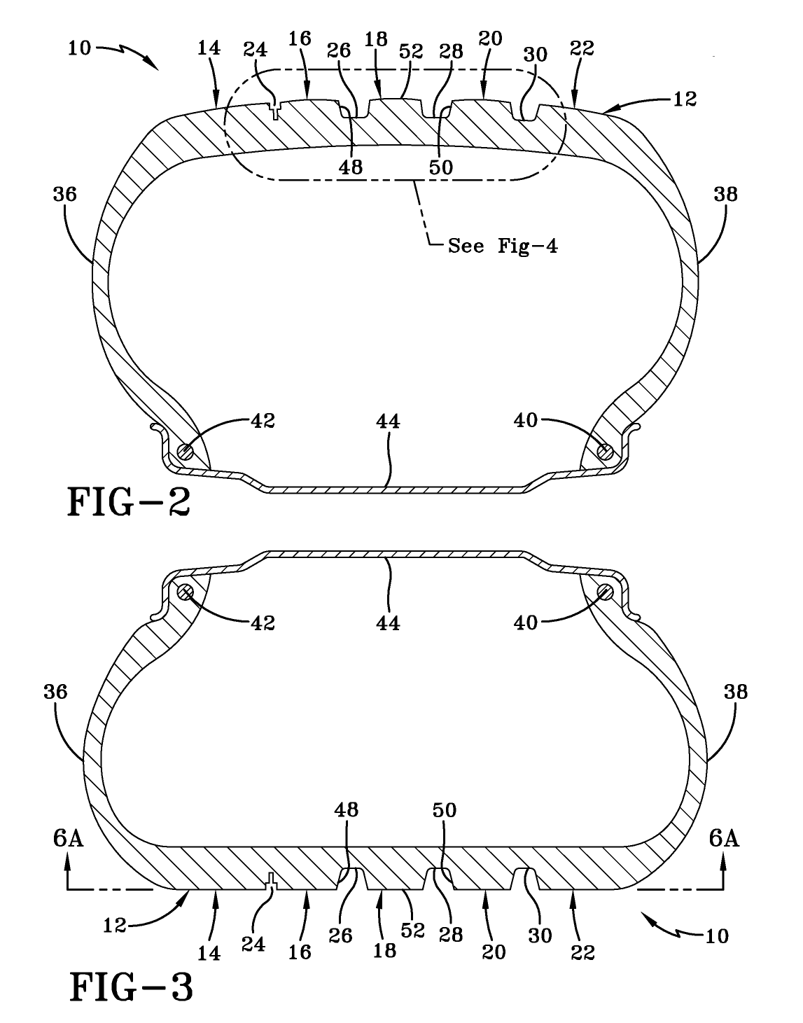

FIG. 2 shows the tread pattern 12 in section. The tire 10 is of conventional construction including a tread or crown region 12, sidewalls 36, 38 and a lower bead portion 40, 42. The tire 10 seats within a rim 44 in use as a wheel assembly. FIG. 3 illustrates the tire in engagement against a ground surface 46, causing deformation of the tread pattern 12 in the formation of a tire footprint. The tire footprint at a given moment is the contacting area of the tread surface engaging against the ground. The greater the contact area of the tread against the ground 46 the greater the traction performance of the tread. The weight or load of the vehicle is distributed through contacting portions of the tread footprint to the ground surface 46. It is desirable to distribute such load pressure evenly across the tire footprint without concentration of the pressure within regions of the tread elements. Such a concentration of pressure reduces the traction performance of the tread and can cause durability issues within the tread as some tread regions wear more rapidly than others.

Each of the ribs 14, 16, 18, 20, 22 is generally constructed having a pair of opposite sidewalls 48, 50 that project radially outward to a contact surface 52 of the rib. As seen from FIG. 3, the rib contact surface 52 flattens against the road surface 46 in the formation of the tire footprint.

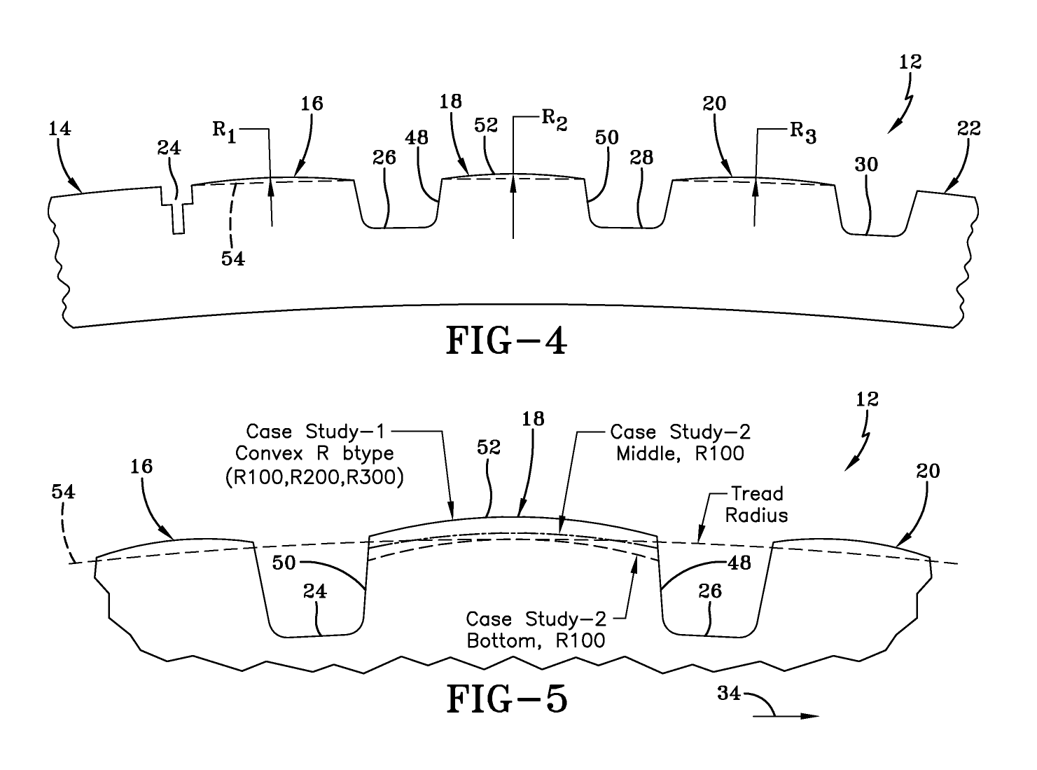

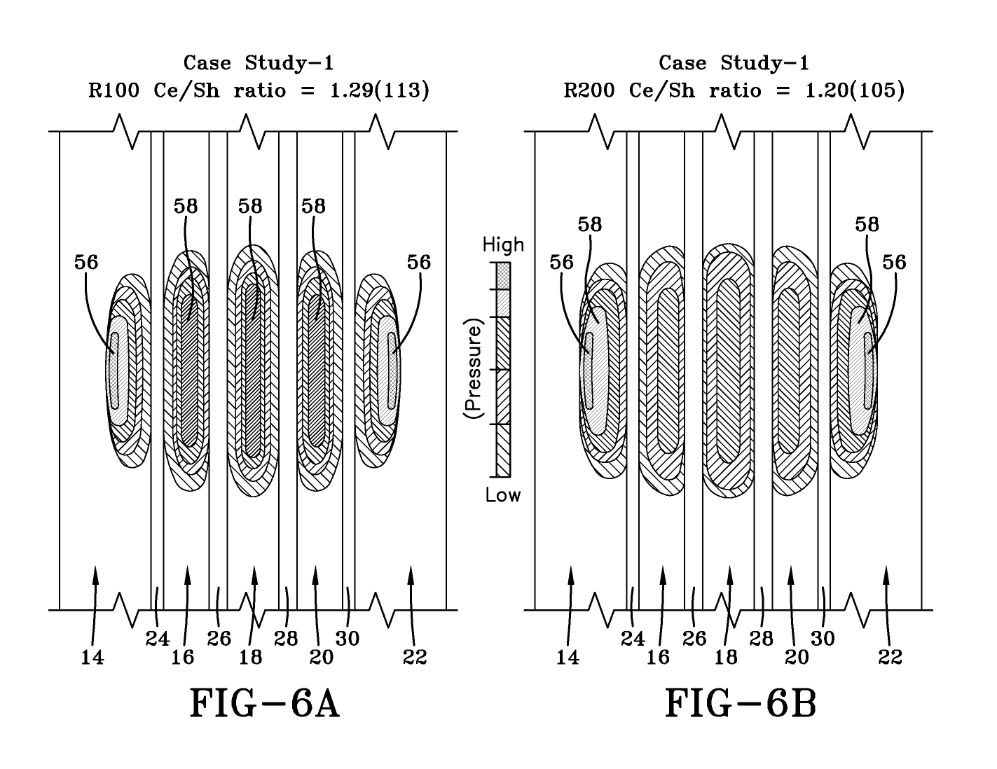

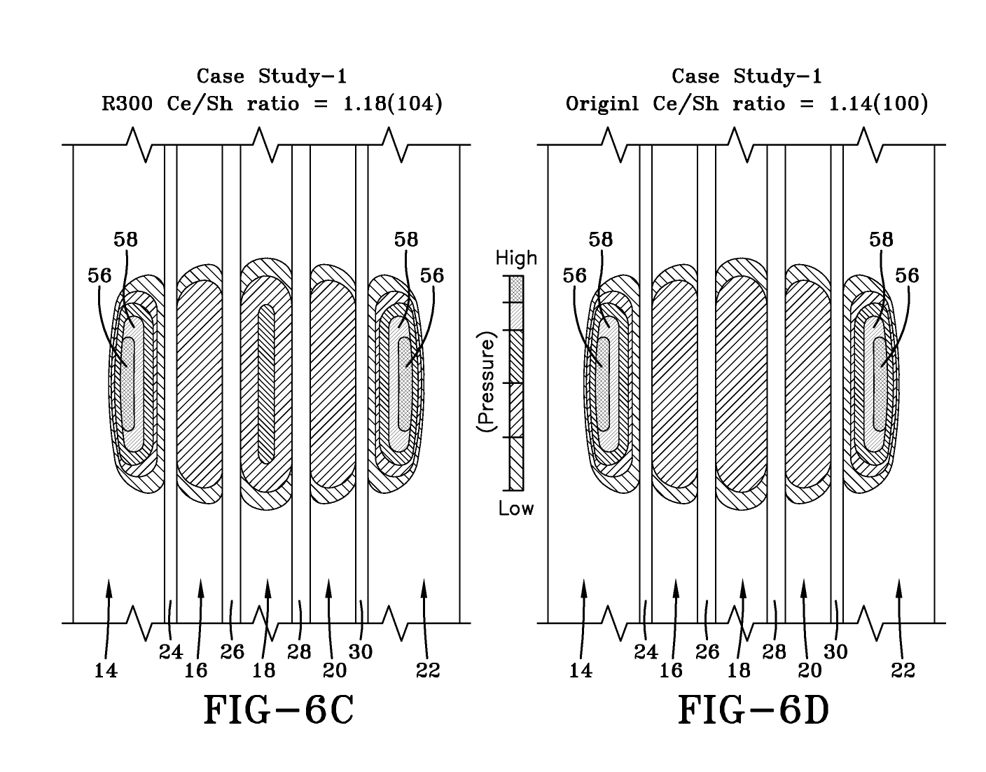

With reference to FIGS. 4 and 5, the tread 12 intermediate ribs 16, 18, and 20 are shown in detail. Each rib has a contact surface 52 that extends generally in parallel with a tire tread radius 54. The tread radius 54 is the radius from the center of the tire and varies according to the size tire. As shown best in FIG. 5, it is beneficial to form the outward surfaces of the center rib 18 to have a convex curvature that is rounded more greatly than the radius of the tread 54. The convex curvature is only in the axial direction indicated by numeral 34. The degree of convexity of the surface 52 was experimentally analyzed in three cases: R (radius)=100 mm; R=200; R=300; and R=original. The results are summarized in FIGS. 6A, 6B, 6C, 6D, in a pressure distribution diagram. The footprint contribution of each rib is shown in each of the FIGS. 6A-D and the pressure distribution indicated. The ratio Ce/Sh indicated in the Figures is an industry utilized ratio of footprint length to width that reflects the degree of roundness of the footprint. Changes in the radius of convex curvature in the rib contact surfaces changes this ratio. A square footprint would have a Ce/Sh ratio of 1. The greater the ratio becomes the more rounded the footprint as seen from a comparison of the footprints of FIGS. 6A=D.

When a tire 10 is deflected by load as shown in FIG. 3, it flattens until the ground contact area multiplied by the inflation pressure equals the load. The tread pattern or tread design is molded into the tread rubber and consists of the circumferential grooves and ribs described above. The ribs may also contain sipes or blades and cross ribs or lugs.

Treadwear is the useful life of a tire as determined by its wearing off due to abrasion on the road surface and depends, among other factors, on tread patterns and footprint area. Treadwear is influenced by pressure distribution across the tire tread footprint and concentrations of pressure on tread elements may cause such elements to wear unevenly relative to the remaining tread.

As seen from FIG. 6A, with a radius of 100 mm, a Ce/Sh ratio of 1.29 results. High pressure concentrations 56 within the footprint result with lesser contact pressure regions 58 observed. In FIG. 6B, a results of a radius of the convex center rib 18 are seen to result in a more rounded footprint (Ce/Sh ration of 1.2); with concentrations of pressure 56, 58 in ribs 14, 22 alone. No high contact pressure on block edges is seen. FIG. 6C shows the pressure distribution in the footprint with a radius of 300 used in the convex center rib 18. FIG. 6D shows the original footprint and its consequential pressure distribution.

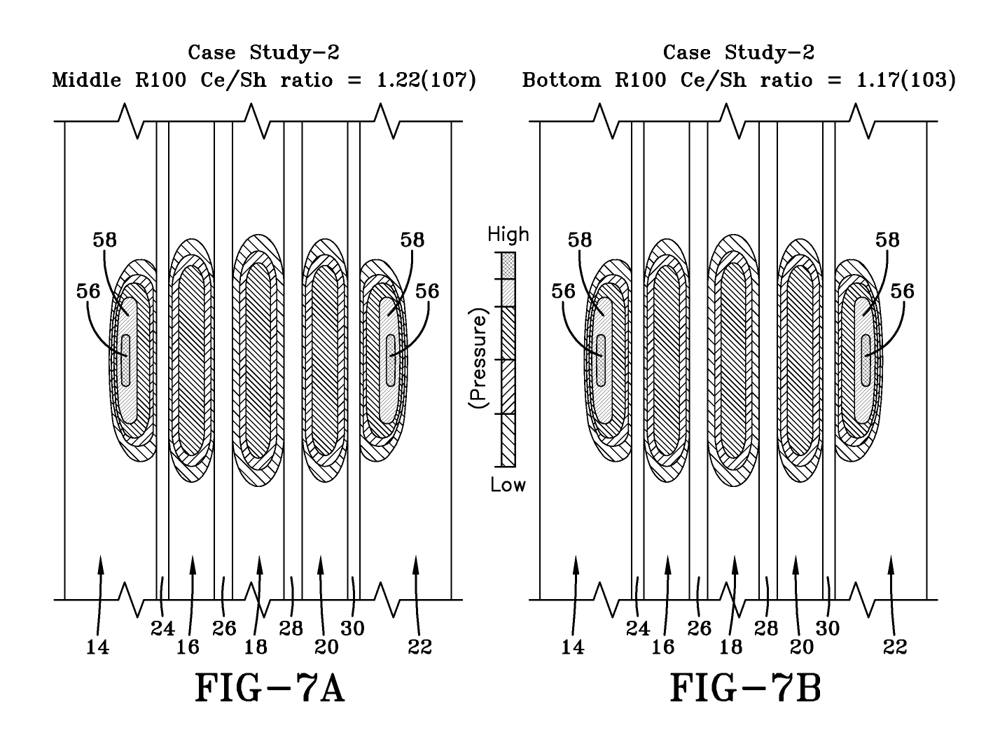

With reference to FIGS. 5, 7A, and 7B, a second case was explored in which the convex curvature of the center rib 18 was varied radially between a middle and bottom location relative to the tread radius, with R held to a constant 100 mm. As seen from the pressure distribution results, concentrations of pressure remained in the outermost ribs.

From the results of the testing, it was determined that the optimal pressure distribution (i.e. the most even pressure distribution) was achieved with the center rib having a convex contact surface radius of 200 mm; the laterally adjacent ribs 16, 20, having a nominal convex contact surface radius of 130, 150 mm, respectively, plus or minus 50 mm. The footprint resulted in a substantially even pressure distribution across the footprint and eliminated pressure concentrations along block edges forming the ribs. The footprint shape was within acceptable Ce/Sh ratio limits; that is not excessively rounded and the study indicated that contact pressure distribution was improved by the incorporation of ribs having the convex curvature in an axial direction. High contact pressure on block edges was thus reduced or eliminated.

While the above is in reference to the tread pattern illustrated, other rib and tread elements constituting the ribs may be employed if desired for other tread performance objectives. The convex shape of the surface 52 of the center rib 18 and adjacent ribs 16, 20 are convex in only the axial direction 34. The degree of convexity, as specified by the respective radii R of the ribs 16, 18, and 20, provide an optimal distribution of contact pressure within the footprint without negatively affecting footprint shape.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A multi-rib tire tread having a plurality of circumferential spaced apart ribs in an axial direction and adjacent ribs separated by a circumferential grooves and each rib having sides extending radially outward to a radially outward contact surface, the outward contact surface of at least one central rib having an outwardly convex curvature in an axial direction relatively more rounded than a tread curvature.

2. The tire tread of claim 1, wherein the convex curvature of the central rib is convex only in the axial direction.

3. The tire tread of claim 1, wherein the radius of curvature of the convex central rib is within a range of 170 to 270 millimeters.

4. The tire tread of claim 1, wherein at least one lateral rib adjacent the center rib has an outwardly convex curvature in an axial direction relatively more rounded than a tread curvature.

5. The tire tread of claim 4, wherein the convex curvature of the lateral rib is convex only in the axial direction.

6. The tire tread of claim 5, wherein the convex curvature of the central rib is greater than the convex curvature of the lateral rib.

7. The tire tread of claim 6, wherein the radius of curvature of the lateral rib is within a range of 100 to 200 millimeters.

8. The tire tread of claim 1, wherein at least a first lateral rib and a second lateral rib are positioned adjacent opposite sides of the central rib, each lateral rib having an outwardly convex curvature in an axial direction more rounded than a tread curvature.

9. The tire tread of claim 8, wherein the convex curvature of the lateral ribs is convex only in the axial direction.

10. The tire tread of claim 8, wherein the convex curvature of the first and second lateral ribs are less rounded than the central rib.

11. The tire tread of claim 10, wherein the radius of curvature of the first lateral rib lies within a range of 80 to 180 millimeters and the radius of curvature of the second lateral rib lies within a range of 100 to 200 millimeters.

12. The tire tread of claim 10, wherein the radius of curvature of the center rib is within a range of 170 and 270 millimeters; the radius of curvature of the first lateral rib is within a range of 80 to 180 millimeters; and the radius of curvature of the second lateral rib is within a range of 100 to 200 millimeters.
